(19) United States
(12) Patent Application Publication
(10) Pub. No.: US 2004/0089249 A1
(43) Pub. Date: May 13, 2004

(54) Engine convertible from two-stroke to four-stroke

(76) Inventor: Zoran Jovanovic, Beograd (YU)

Correspondence Address: John Russell Uren, 1337 Gulf Road, Box 1304, Pt Roberts, WA, 98281-1304, US

(21) Appl. No.: 10/451,484

(22) PCT Filed: Feb. 7, 2001
(86) PCT No.: PCT/YU01/00002

(30) Foreign Application Priority Data
Dec. 21, 2000 (YU) P-820/00

(51) Int. Cl. F02B 69/06

(52) U.S. Cl. 123/21; 123/305

(57) ABSTRACT

This ICE combines the advantages of a four-stroke engine and the power output of a two-stroke and air engines. The air charged from the high pressure receiver (1) is charged the engine through the electric valve (4) independently of the fuel and enables, due to a great difference in pressures, fast performance of the process eliminate intake and compression strokes which results in a two-stroke cycle operation. Depending on the degree of air reduction, the mode of operation of atmospheric or turbocharged engine can be achieved. Replacing of the mechanical exhaust valve (6) with the electric valve (7a, 7b) enables switching from two-stroke to four stroke mode of operation and vice versa only by the computer 2 instruction. Location of the fuel nozzle (5) directly in the compression chamber and its operation independently from the electric air valve (4) enable use of the petrol, gas and oil.

### FIELD OF TECHNICAL SCIENCE TO WHICH THE INVENTION REFERS

The invention belongs to the field of mechanics, the part dealing with the internal combustion engines (ICE) Its designation, according to the international classification of patents (ICP) is F 02 M.

### TECHNICAL ISSUE

This solution enables the engine designed as a four-stroke engine to operate either as a two-stroke engine only or both as a two-stroke and a four-stroke engine. This means that the respective mode of operation, powerful or economic, can be chosen depending on the situation in the traffic. This engine can also operate either on petrol or Diesel as well as on the atmospheric or compressed air pressure.

### TECHNICAL SITUATION

The ICE is designed either as a two-stroke engine (high power output, but problems with lubrication, cooling, great losses in the channels) or as a four-stroke engine (excellent lubrication, cooling, higher fuel efficiency ratio but with much lower power output per liter and greater number of moving parts i.e. a more complex and risky structure).

### STATING OF THE ESSENCE OF THE INVENTION

Novelties in the design of this engine are: its air compartment receiver under the pressure of several tens of bars; its aircharger; use of the electric valve (instead of the mechanical intake valve) not only for the passage of air but for the pressure reduction as well; the exhaust valve which can be executed in several versions. Such changes enable the essential feature of this invention i.e. elimination of two strokes in the working cycle: intake and compression. The result is operation in a two-stroke mode in a completely new way.

Whether the engine is going to operate in a two-stroke or a in a four stroke mode depends on the exhaust valve; when it is a classic, camshaft driven valve, the engine operates exclusively as a two-stroke engine but if it is an electric valve, with the orifice or a classic electrically driven valve (computer controlled in both cases), the engine can operate both as a two-stroke and as a four-stroke engine.

The advantages of the engine which operates on the above stated principle are:

It combines the advantages of the designs of a four-stroke engine (such as: better lubrication, cooling, sealing, elimination of partial power losses due to the channel non-sealing etc) and of a two-stroke engine where the power output is theoretically two times higher.

Electronic process control enables choice of the mode of operation during the drive:

powerful-two-stroke cycle or economic-four-stroke cycle.

The air pressure of several tens of bars which is charged to the engine from the air compartment receiver and computer controlled quantity and pressure of the air portion which is charged to the cylinder enable the engine to behave as a compressed air engine i.e. enable increase of its power output for more than two times.

Separate air and fuel nozzles enable use of all types of fuels which are currently in use for ICE.

### SHORT DESCRIPTION OF THE FIGURES

FIG. 1 represents a general view of the engine

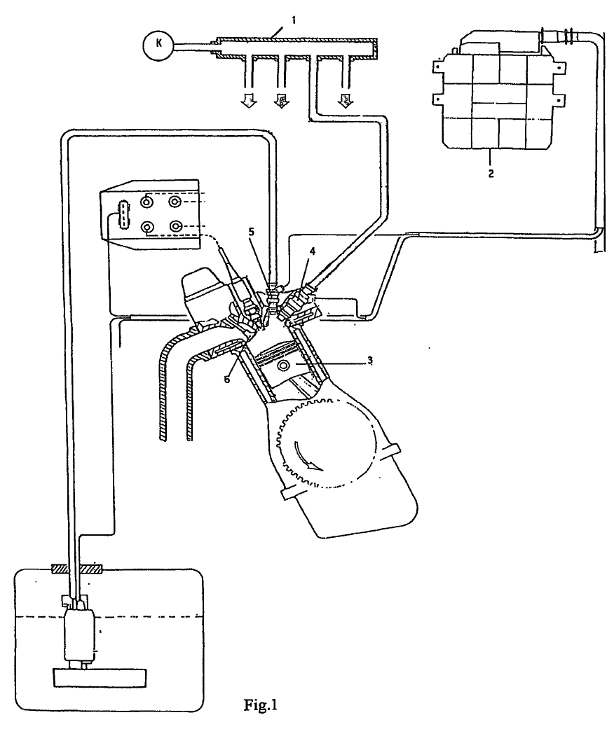

FIG. 2 represents versions of the exhaust valve design

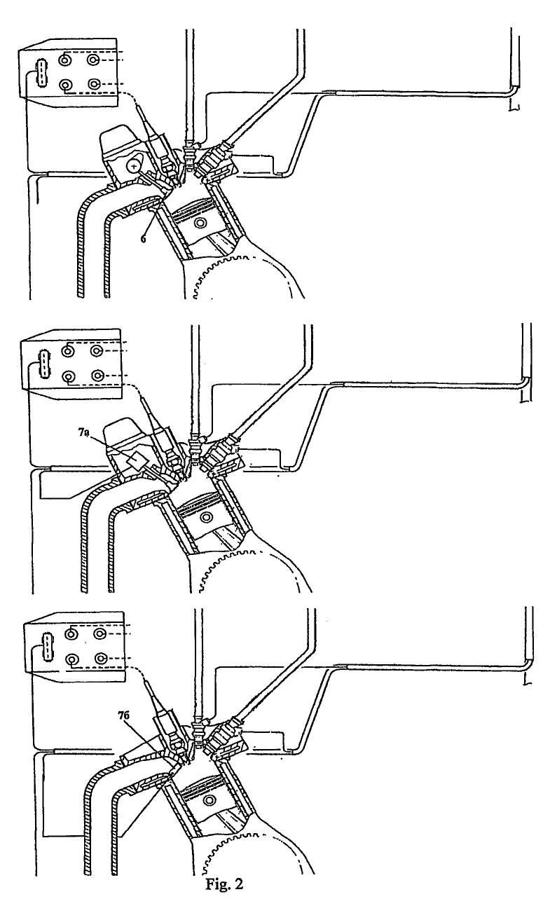

FIG. 3 represents a scheme of the principle of engine operation—essence of the idea

FIG. 4 represents ambivalent mode of operation of the engine—as a two-stroke and as a four-stroke engine

### DETAILED DESCRIPTION OF THE INVENTION

The essence of this invention is the principle of engine operation, performance of the processes in a way which has not been applied, yet. This requires introduction of new solutions in its design. They comprise: high pressure air compartment receiver 1 which is aircharged from the compressor K; electric air intake valve 4 which acts as a pressure reducer as well; electric exhaust valve (which can replace the camshaft driven mechanical valve), executed in two versions: version 7a which is executed as a classic type mechanical valve with the electric drive and version 7b executed as the electric valve with orifice.

The description of the process shows theoretic features e.g. the spark plug sparks in the top dead centre, the exhaust valve opens in the bottom dead centre and closes in the top dead centre. In practice, all this is displaced and depends on what the engine is intended for. Then, all the explanations refer to the engine on petrol while when Diesel fuel is used, some differences in design are required but the principle of operation remains the same.

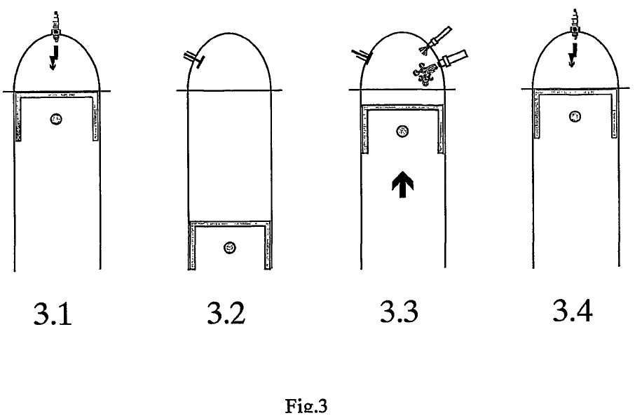

We start to follow the cycle from the moment when the piston 3 is in the top dead centre (TDC), all the valves are closed, the mixture is compressed and the spark plug sparks. The working stroke begins. (FIG. 3.1).

The piston 3 has reached the bottom dead centre (BDC), the working stroke is over, the exhaust valve 6 opens and the exhaust stroke begins (FIG., 3.2).

The piston 3 is very close to the TDC. At that moment the specific feature of this engine, the feature which makes it different from other engines appears. The exhaust valve 6 closes and the air under pressure, approx. equal to the degree of compression (conditions similar to the conditions in the atmospheric air engine) is charged through the electric intake valve 4 the quantity of the charged air is respective to the volume of the compression chamber. At the same time, the fuel is injected through the nozzle 5 and the mixture is prepared. Due to the great difference in pressures, the process is performed so quickly, in only several degrees of crankshaft revolution so that the intake stroke practically does not exist. Likewise, as the air i.e. the mixture, has already been compressed to the requested degree of compression i.e. its volume is equal to the volume of the compression chamber and the piston 3 is in its upward stroke very close to the TDC; thus there is no compression stroke.

In the FIG. 3.4., the piston 3 has reached TDC, all the valves are closed, the spark plug sparks and we have the same situation as in the FIG. 3.1. The working stroke begins and the complete process repeats.

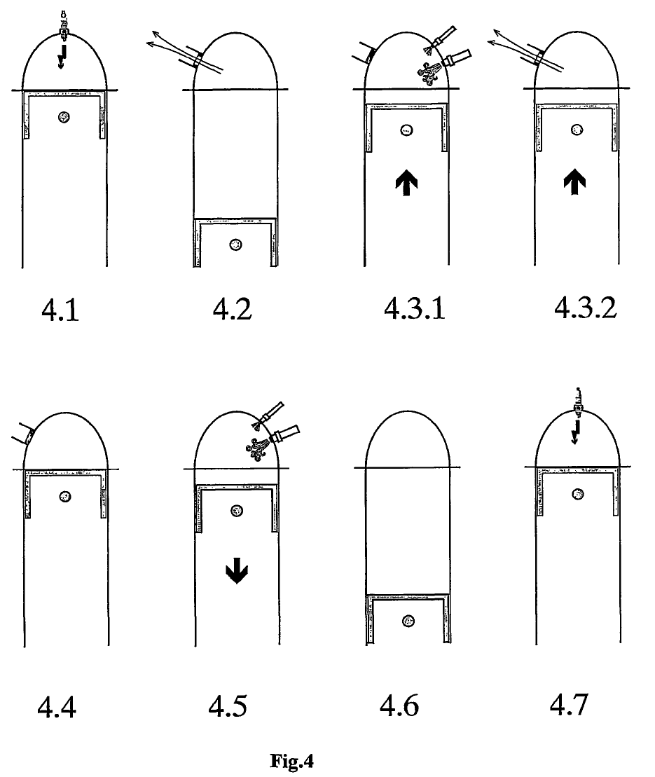

When, instead the exhaust valve 6, which is driven in the usual way, by the camshaft, the version with the electric exhaust valves 7a or 7b is applied, the engine which operates as an exclusively two-stroke engine turns into the engine which can operate both as a two-stroke or a four-stroke one. The operation of such engine is shown in the FIG. 4. The version 7b of the exhaust valve is shown because of its better view in the drawing.

The first part of the engine operation, shown in the FIGS. 4.1. and 4.2. is same as with the exclusively two-stroke engine shown in the FIGS. 3.1 and 3.2. Decision whether the engine is going to operate as a two-stroke or a four-stroke one is made at the moment when the piston 3 is near TDC. If the exhaust valve 7b is closed (FIG. 4.3.1), the electric air intake valve 4 and fuel nozzle 5 open and we have the situation identical to the one in the FIG. 3.3. The engine operates as a two-stroke one. But if the exhaust valve 7b is still open at that moment (FIG. 4.3.2), the piston 3 moves upward to the TDC (FIG. 4.4) and only then the valve 7b closes. The piston 3 moves downward (FIG. 4.5) and charging of air under pressure of about one bar as well fuel injection start Now the engine operates as a four-stroke atmospheric air engine. In the FIG. 4.6, the piston has reached BDC and air charging and fuel injection stop. The intake stroke is completed and the compression stroke begins. In the FIG. 4.7, the piston 3 has reached BDC, the spark plug sparked and we have the same situation as in the FIG. 4.1. The cycle is completed.

Such system enables change of stroke mode during the operation depending on the computer 2 instructions at the critical moments shown in FIGS. 4.3.1 and 4.3.2.

Computer 2 also controls the air pressure in the cylinder in accordance with the instructions so that the engine can behave either as the atmospheric and as a turbocharged engine.

The design with separated air and fuel nozzles controlled by the computer 2 enables application of this principle in all ICE which operate on the fuels known by now: petrol, gas and oil.

1. Engine with in-drive stroke cycle conversion by elimination of two strokes designed and operating as a four-stroke engine where the lubrication oil space is separated from the working space where the working fluid circulates and which is located above the piston (3) with the working fluid intake and exhaust orifices in the cylinder head is characterized by the possibility of momentary injection of the air at pressure which corresponds the degree of compression which results in a new principle of operation based on elimination of the intake and compression strokes, which makes the engine operate as a two-stroke engine at that moment i.e. the change of the stroke cycle during the drive at the driver's discretion and this new principle can be applied regardless of the engine RPM due to the charging of air from the high pressure compartment receiver (1) or directly from the compressor (K) (if its construction would ensure constant pressure in the installation) over the multi-function electric valve(s) (4) with simultaneous injection of the fuel through one of the nozzles (5.1, 5.2) at the moment when the piston (3) is several degrees before TDC and. exhaust valve (7) is already closed, all being synchronized by an ECU (2).

2. Engine with in-drive stroke cycle conversion by elimination of two strokes is air charged characterised by high pressure compartment receiver (1) which consists of the first part which receives the air from the compressor (K) with the variable pressure and the second part which receives the air from the first part over a non return valve, and stabilizes it; the primary task of such a receiver is to keep the air pressure constant in the installation all the way to the multi-function electric valve(s) (4) at the values which range from several tens to several hundreds bars depending on the features of the designed speed of the process execution, while the secondary function of the so designed receiver is to enable the compressor (K) to rest and to start again when the motor does not need the power—at down-slope, braking etc.

3. Engine with in-drive stroke cycle conversion by elimination of two strokes control of the quantity of air which is charged into the cylinder is characterised by multi-function electric valve(s) (4), -one or more than one -(applying the same criteria according to which the number of valves for the classic mechanical design is determined), the function of which is: a) to reduce pressure from the installation to the required value (to 1 bar in a four-stroke cycle, to the value relevant to the degree of compression in a two-stroke cycle and to a super-pressure in turbo operation), b) to enable the respective duration of air charging (the complete stroke in a four-stroke cycle or almost momentarily in a two-stroke cycle), c) to ensure the respective frequency of opening (each second piston stroke (3), downwards in the four-stroke cycle and each stroke downward in the two-stroke cycle).

4. Engine with in-drive stroke cycle conversion by elimination of two strokes fluid feeding is characterised by two separate fuel injection nozzles (5), one for petrol or gas (5.1) and one for (5.2) for Diesel.

5. Engine with in-drive stroke cycle conversion by elimination of two strokes exhausting of the combustioned air is characterised by the electric valve (7) which enables change of the number of strokes, from four to two or vice versa, without interruption of the engine operation.

6. The electric valve according to the patent claim 5 and according to the version 1, is of a standard design characterised by being driven by the electric motor (7a) which it makes one unit with.

7. The electric valve according to the patent claim 5 and according to the version 2, is characterised by a ring shaped orifice (7b).
